(19) United States
(12) Patent Application Publication
(10) Pub. No.: US 2024/0079797 A1
(43) Pub. Date: Mar. 7, 2024

(54) MULTI-TAP COMPRESSION CONNECTOR ASSEMBLY FOR SECURING WIRES THEREIN

(71) Applicant: Oriental Export Corporation, Mumbai (IN)

(72) Inventors: NARESH SHUDRA, Mumbai (IN); Nitin Patil, Mumbai (IN)

(21) Appl. No.: 18/456,664

(22) Filed: Aug. 28, 2023

(51) Int. Cl. H01R 4/18; H01R 4/36; H01R 4/70

(52) U.S. Cl. CPC H01R 4/186; H01R 4/36; H01R 4/70

(57) ABSTRACT

The present disclosure relates generally to “Tapping”. The present invention discloses a compression connector assembly for securing wires therein. The compression connector assembly includes a connector having a central groove to accommodate a main wire there through, a plurality of tap wire holes, and a plurality of pointed and piercing teeth's facing towards the accommodated main wire. Each of the plurality of tap wire holes adapted to accommodate at least one tap wire there through. Further, the pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

### TECHNICAL FIELD

The present disclosure relates generally to a field of electrical engineering and to “tapping” which is an electrical term meaning adding new tap wiring to an existing main wire, and more particularly it relates to multi-tap compression connector assembly for securing wires therein.

### BACKGROUND

Insulated wire cables typically include a core conductor and a separate insulated shield conductor surrounding the core conductor insulation. The shield conductor may consist of a braided wire mesh, metal foil, or metalized film. The cables typically have a second insulation layer covering the shield conductor. Shielded wire cables have been long used for communications systems, such as in cable television transmission lines. Shielded wire cables are also finding use in high voltage applications in electric and hybrid electric vehicles and many more applications these days.

When shielded wire cables are spliced together, there is usually a need to electrically connect the shield conductors of the spliced cables as well as the core conductor, in order to maintain electrical continuity of the shield conductors. Interconnecting the shield conductors may be complicated because the shield conductors must be cut back from the spliced ends of the cable in order to join the core conductors. Interconnecting the shield conductors may be further complicated in a one-to-many splicing configuration, sometimes referred to as a Y-splice.

A prior art method splicing shielded wire cables involved joining the centre conductors of the cables using a crimping connection, covering the crimped joint with an insulator, such as heat shrinkable tubing and then covering the exposed shield conductors and insulated joint with a flux coated solder impregnated conductive sleeve within a section of heat shrinkable tubing. Such a solder impregnated conductive sleeve within a section of heat shrinkable tubing is available from TE Connectivity Corporation of Menlo Park Calif (formerly Tyco Corporation) under the brand name Solder Shield.

Further, conventionally, tap splicers are also referred to as Quick Splicers and are designed for use with electrical wires, some telephone wiring and other electrical device wires. Tap slice connectors are designed to feed an existing wire and a new clean cut end of another wire into it. When the metal portion of the tap splice is pressed down, it cuts into both wires and establishes a connection between the two wires. The plastic casing folds over and securely holds the wires, without stripping the insulation jacket, to make a tight and clean connection between the wires. The connection is completed when the tap casing is closed and crimped tightly.

Many electrical accessories today come with connectors that are designed to “splice” connections into other wires without the need for cutting and soldering. These connectors are commonly referred to as “vampire connectors” because they “bite” into another wire to “suck” power.

However, what is noted in the existing wire connectors and splicers is that present wire connector available in market with narrow range of wire. For example, one connector can accommodate at the most two tapings. Further, the simple act of pressing in the existing wire connectors and splicers causes the wire into this slotted metal piece to bludgeon. The concept behind this is fine—it's supposed to strip back the insulation on the wire to make contact with the wire itself. The problem is that there is no guarantee that the pressing would not accidentally catch some of the wire in this process and tear some of the individual wire strands. It is actually quite common that this does happen. Second, when the connection process does strip the insulation without completely trashing the wire then the opposite is sometimes true—it only makes limited contact with the wire.

Also, both the over and under “stripped” problems mentioned above are often exacerbated by users who do not realize the color/sizing relationship of these connectors to the wires. If a user chooses a size too big or a size too small for the wire, and tapping into then the user will end up with an exaggerated version of the 2 problems discussed above.

Therefore, there is a need for an improved connector device that overcomes the limitations of conventional techniques, an provide a secure, stable, and reliable multi-tap compression connector assembly for securing at least up to four wires (taps) therein.

### SUMMARY

The present disclosure relates generally to a field of electrical engineering and to “Tapping” which is an electrical term meaning adding new tap wiring to an existing main wire, and more particularly it relates to multi-tap compression connector assembly for securing wires therein.

Accordingly, an aspect of the present invention discloses a compress 10n connector assembly for securing wires therein. The compression connector assembly includes a connector having a central groove to accommodate a main wire there through, a plurality of tap wire holes, and a plurality of pointed and piercing teeth's facing towards the accommodated main wire.

Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

Another aspect of the present invention relates to a compression connector assembly for securing wires therein. The compression connector assembly includes a connector having a central groove to accommodate a main wire there through, a plurality of tap wire holes, and a plurality of pointed and piercing teeth's facing towards the accommodated main wire.

Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

The compression connector assembly further includes an insulation cover adapted to enclose the connector therein, wherein the insulation cover comprises a plurality of through and through holes, matching the central groove and the plurality of tap wire holes of the enclosed connector, to allow entry and exit of the main wire and the at least one tap wire there through.

Another aspect of the present invention relates to a compression connector for securing wires therein. The compression connector includes a connector having a central groove to accommodate a main wire there through, a plurality of tap wire holes, and a plurality of pointed and piercing teeth's facing towards the accommodated main wire. Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

It is an important aspect of the compression connector assembly that the connector once compressed and installed is non-reusable (one time use/use ad through) as the head of each of the sheared screws once installed are broken after being tightened/installed into the tape wire holes.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIGS. 1A-1B illustrates an isometric view and a side view of a compression connector for securing wires therein, in accordance with the exemplary embodiment of the present subject matter.

FIGS. 2A-2C illustrates a compression connector assembly with wires secured therein, in accordance with the exemplary embodiment of the present subject matter.

FIG. 3A illustrates a front view of an insulation cover adapted to enclose the connector, in accordance with the exemplary embodiment of the present subject matter.

FIG. 3B illustrates an isometric view of an insulation cover having enclosed the connector with wires secured therein, in accordance with the exemplary embodiment of the present subject matter.

FIGS. 4A-4B illustrates an insulation cover in open position for receiving a compression connector before enclosing the compression connector, in accordance with the exemplary embodiment of the present subject matter.

### DETAILED DESCRIPTION

Some embodiments of the present disclosure, illustrating all its features, will now be discussed in detail. It must also be noted that as used herein and in the appended claims, the singular forms “a”, “an” and “the” include plural references unless the context clearly dictates otherwise.

The present disclosure relates generally to a file of electrical engineering and to “Tapping” which is an electrical term meaning adding new tap wiring to an existing main wire, and more particularly it relates to multi-tap compression connector assembly for securing wires therein.

Accordingly, an embodiment of the present invention discloses a compression connector assembly for securing wires therein. The compression connector assembly includes a connector having a central groove to accommodate a main wire there through, a plurality of tap wire holes, and a plurality of pointed and piercing teeth's facing towards the accommodated main wire.

Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

Another embodiment of the present invention relates to a compress 10n connector assembly for securing wires therein. The compression connector assembly includes a connector having a central groove to accommodate a main wire there through, a plurality of tap wire holes, and a plurality of pointed and piercing teeth's facing towards the accommodated main wire.

Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

The compression connector assembly further includes an insulation cover adapted to enclose the connector therein, wherein the insulation cover comprises a plurality of through and through holes, matching the central groove and the plurality of tap wire holes of the enclosed connector, to allow entry and exit of the main wire and the at least one tap wire there through.

Another embodiment of the present invention relates to a compress 10n connector for securing wires therein. The compression connector includes a connector having a central groove to accommodate a main wire there through, a plurality of tap wire holes, and a plurality of pointed and piercing teeth's facing towards the accommodated main wire. Each of the plurality of tap wire holes adapted to accommodate at least one tap wire there through. Further, each of the plurality of pointed and piercing teeth's are provided surrounding to the central groove such that when the connector is pressed the plurality of pointed and piercing teeth's creates a cut on the accommodated main wire and the at least one accommodated tap wire to thereby establish a splice connection between the accommodated main wire and the at least one accommodated tap wire.

The present disclosure, in an exemplary embodiment discloses a multi-tap compression connector assembly for securing wires therein.

### PART LIST

compression connector assembly 100;
connector 102;
central groove 104;
main wire 106;
tap wire holes 108-1, 108-2, 108-3, 108-4;
tap wire 110-1, 110-2, 110-3, 110-4;
piercing teeth's 112-1, 112-2, 112-3, 112-4;
insulation cover 114;
holes 116-1, 116-2, 116-3, 116-4, 116-5;
sheared screws 118;
gel 120 for gel potting compound providing rain/water tight feature for connector;
placement guides 122.

The present invention relates generally to the field of electrical connectors and more particularly to an improved connector for tapping power from an insulated electrical conductor.

A connector for tapping electrical current from an insulated electrical cable/wire at a point intermediate the ends of said cable/wire is providing. The connector is an Aluminium (C) Compression (I) Insulation (P) Piercing (C) Connector (Aluminium CIPC connector) is an electrical tap solution. Basically, it is a C-Tap Aluminium Connector.

In a first embodiment, a compression connector assembly 100 for securing wires therein is provided. The compression connector assembly 100 includes a connector 102 having a central groove 104 to accommodate a main wire 106 (also interchangeably referred to as “main cable”) therethrough, a plurality of tap wire holes 108-1, 108-2, 108-3, 108-4, and a plurality of pointed and piercing teeth's 112-1, 112-2, 112-3, 112-4 facing towards the accommodated main wire 106.

In this embodiment, each of the plurality of tap wue holes adapted to accommodate at least one tap wire 110-1, 110-2, 110-3, 110-4 (also interchangeably referred to as “tap connection”) there through. Further, each of the plurality of pointed and piercing teeth's 112-1, 112-2, 112-3, 112-4 are provided surrounding to the central groove 104. When the connector 102 is pressed the plurality of pointed and piercing teeth's 112-1, 112-2, 112-3, 112-4 pierces the accommodated main wire 106 and the at least one accommodated tap wire 110-1, 110-2, 110-3, 110-4 to thereby establish a splice connection between the accommodated main wire 106 and the at least one accommodated tap wire 110-1, 110-2, 110-3, 110-4. Thus, upon piercing, the connector 102 acts as a conductor.

In an exemplary implementation of the first embodiment, the connector 102 is a C-shaped connector or is a substantially C-shaped.

In an exemplary implementation of the first embodiment, each of the plurality of pointed and piercing teeth's 112-1, 112-2, 112-3, 112-4 are conductive piercing teeth adapted to maintain splice connection connectivity between the accommodated main wire and the at least one accommodated tap wire.

In an exemplary implementation of the first embodiment, the main wire 106 and the at least one tap wire 110-1, 110-2, 110-3, 110-4 is a shielded wire cable having a core conductor at least partially axially surrounded by a shield conductor which is at least partially axially surrounded by an insulative jacket.

In an exemplary implementation of the first embodiment, the main wire 106 is an aluminum photovoltaic (PV) cable.

In an exemplary implementation of the first embodiment, the at least one tap wire 110-1, 110-2, 110-3, 110-4 is a copper photovoltaic (PV) cable.

In an exemplary implementation of the first embodiment, each of the plurality of tap wire holes 108-1, 108-2, 108-3, 108-4 accommodate a single tap wire, and the connector is adapted to include maximum up to four tap wires.

In an exemplary implementation of the first embodiment, the connector 102 is made of aluminum (Al) material.

In an exemplary implementation of the first embodiment, the connector 102 includes a plurality of pre-fitted sheared screws 118, each of the plurality of pre-fitted sheared screws 118 connecting to respective tap wire holes of plurality of tap wire holes such that the at least one tap wire passing through the respective tap wire holes are tightened using a screw driver.

In an exemplary implementation of the first embodiment, the assembly 100 further includes an insulation cover 114 adapted to enclose the connector 102 therein. The insulation cover 114 includes a plurality of through and through holes 116-1, 116-2, 116-3, 116-4, 116-5 matching the central groove 104 and the plurality of tap wire holes 108-1, 108-2, 108-3, 108-4 of the enclosed connector, to allow entry and exit of the main wire 106 and the at least one tap wire 110-1, 110-2, 110-3, 110-4 therethrough.

In an exemplary implementation of the first embodiment, the insulation cover 114 is adapted to receive the connector 102 at placement guides 122 provided centrally at the insulation cover when in open position and completely encloses the connector in closed position of the insulation cover. The guides ensure wires seat in the gel properly.

In an exemplary implementation of the first embodiment, the insulation cover 114 comprises a snap fit mechanism to close the insulation cover.

In an exemplary implementation of the first embodiment, the insulation cover comprises a gel 120 that enables the main wire 106 and the at least one tap wire 110-1, 110-2, 110-3, 110-4 to seat rigidly inside and thereby seals surrounding parts inside cover to form a seal tight enclosure for the connector.

In a second embodiment, a compression connector assembly for securing wires therein is disclosed. The compression connector assembly includes a connector 102 having a central groove 104 to accommodate a main wire 106 therethrough, a plurality of tap wire holes 108-1, 108-2, 108-3, 108-4, and a plurality of pointed and piercing teeth's 112-1, 112-2, 112-3, 112-4 facing towards the accommodated main wire 106.

In this embodiment, each of the plurality of tap wire holes adapted to accommodate at least one tap wire 110-1, 110-2, 110-3, 110-4 therethrough. Further, each of the plurality of pointed and piercing teeth's 112-1, 112-2, 112-3, 112-4 are provided surrounding to the central groove 104. When the connector 102 is pressed the plurality of pointed and piercing teeth's 112-1, 112-2, 112-3, 112-4 creates a cut on the accommodated main wire 106 and the at least one accommodated tap wire 110-1, 110-2, 110-3, 110-4 to thereby establish a splice connection between the accommodated main wire 106 and the at 1 east one accommodated tap wire 110-1, 110-2, 110-3, 110-4.

Further, in this embodiment, an insulation cover 114 is provided that is adapted to enclose the connector 102 therein. The insulation cover 114 includes a plurality of through and through holes 116-1, 116-2, 116-3, 116-4, 116-5 matching the central groove 104 and the plurality of tap wire holes 108-1, 108-2, 108-3, 108-4 of the enclosed connector, to allow entry and exit of the main wire 106 and the at least one tap wire 110-1, 110-2, 110-3, 110-4 therethrough.

In an exemplary implementation of the second embodiment, the insulation cover 114 is adapted to receive the connector 102 at placement guides 122 provided centrally at the insulation cover when in open position and completely encloses the connector in closed position of the insulation cover.

In an exemplary implementation of the second embodiment, the insulation cover 114 comprises a snap fit mechanism to close the insulation cover.

In an exemplary implementation of the second embodiment, the insulation cover comprises a gel 120 that enables the main wire 106 and the at least one tap wire 110-1, 110-2, 110-3, 110-4 to seat rigidly inside and thereby seals surrounding parts inside cover to form a seal tight enclosure for the connector.

In a third embodiment, a compression connector 102 for securing wires therein is disclosed. The compression connector includes a central groove 104 to accommodate a main wire 106 therethrough, a plurality of tap wire holes 108-1, 108-2, 108-3, 108-4, and a plurality of pointed and piercing teeth's 112-1, 112-2, 112-3, 112-4 facing towards the accommodated main wire 106.

In this embodiment, each of the plurality of tap wue holes adapted to accommodate at least one tap wire 110-1, 110-2, 110-3, 110-4 therethrough. Further, each of the plurality of pointed and piercing teeth's 112-1, 112-2, 112-3, 112-4 are provided surrounding to the central groove 104. When the connector 102 is pressed the plurality of pointed and piercing teeth's 112-1, 112-2, 112-3, 112-4 creates a cut on the accommodated main wire 106 and the at least one accommodated tap wire 110-1, 110-2, 110-3, 110-4 to thereby establish a splice connection between the accommodated main wire 106 and the at least one accommodated tap wire 110-1, 110-2, 110-3, 110-4.

In an exemplary implementation of the third embodiment, the connector 102 is a C-shaped connector or is a substantially C-shaped.

In an exemplary implementation of the third embodiment, each of the plurality of pointed and piercing teeth's 112-1, 112-2, 112-3, 112-4 are conductive piercing teeth adapted to maintain splice connection connectivity between the accommodated main wire and the at least one accommodated tap wire.

In an exemplary implementation of the third embodiment, the main wire 106 and the at least one tap wire 110-1, 110-2, 110-3, 110-4 is a shielded wire cable having a core conductor at least partially axially surrounded by a shield conductor which is at least partially axially surrounded by an insulative jacket.

In an exemplary implementation of the third embodiment, the main wire 106 is an aluminum photovoltaic (PV) cable.

In an exemplary implementation of the third embodiment, the at least one tap wire 110-1, 110-2, 110-3, 110-4 is a copper photovoltaic (PV) cable.

In an exemplary implementation of the third embodiment, each of the plurality of tap wire holes 108-1, 108-2, 108-3, 108-4 accommodate a single tap wire, and the connector is adapted to include maximum up to four tap wires.

In an exemplary implementation of the third embodiment, the connector 102 is made of aluminum (Al) material. Preferably, compression connector is a one-piece member made of electrically conductive material, such as aluminum or copper. However, it is likewise contemplated that compression connector may be made of any suitable materials or elements that will withstand a crimping operation.

In an exemplary implementation of the third embodiment, the connector 102 includes a plurality of pre-fitted sheared screws 118, each of the plurality of pre-fitted sheared screws 118 connecting to respective tap wire holes of plurality of tap wire holes such that the at least one tap wire passing through the respective tap wire holes are tightened using a screw driver.

It is an important aspect of the compress 10n connector assembly that the connector once compressed and installed is non-reusable (one time use/use ad through) as the head of each of the sheared screws once installed are broken after being tightened/installed into the tape wire holes.

The embodiments of the present invention would not be explained with the help of figures:

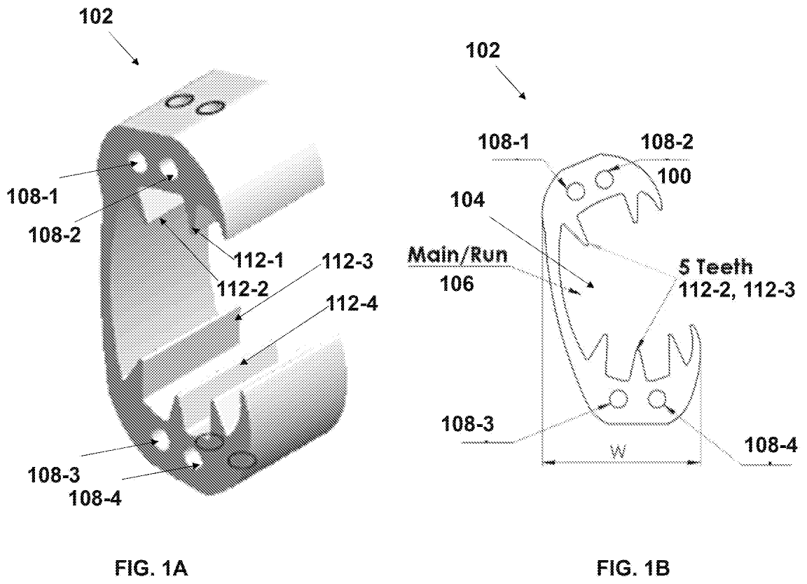

FIGS. 1A-1B illustrates an isometric view and a side view of a compression connector for securing wires therein, in accordance with the exemplary embodiment of the present subject matter.

As shown in FIGS. 1A and 1B, a compression connector 102 for securing wires therein is disclosed. The compression connector includes a central groove 104 to accommodate a main wire therethrough, a plurality of tap wire holes 108-1, 108-2, 108-3, 108-4, and a plurality of pointed and piercing teeth's 112-1, 112-2, 112-3, 112-4 facing towards the central groove 104.

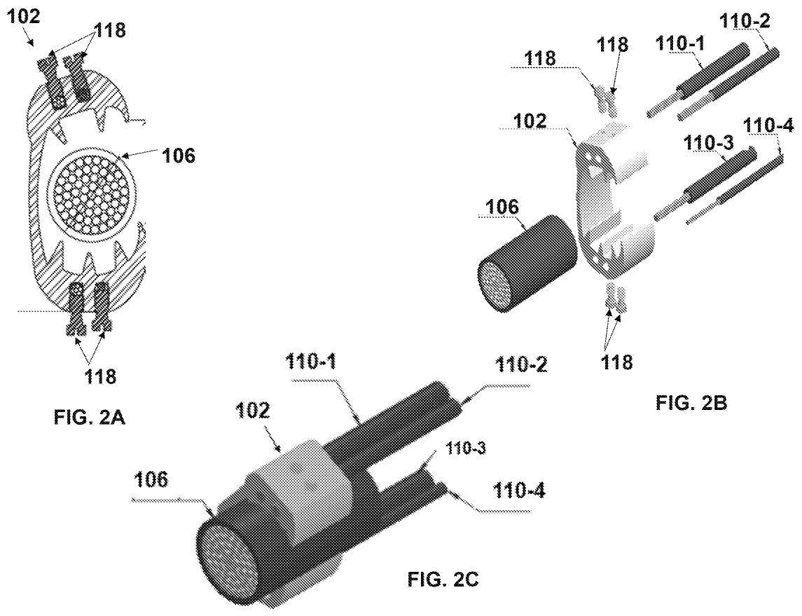

FIGS. 2A-2C illustrates a compression connector assembly with wires secured therein, in accordance with the exemplary embodiment of the present subject matter.

As shown in FIGS. 2A-2C, a compression connector 102 for securing wires therein is disclosed. The compression connector includes a central groove to accommodate a main wire 106 therethrough, at least one tap wire 110-1, 110-2, 110-3, 110-4 adapted to pass through the plurality of tap wire holes. Further, the connector 102 includes a plurality of pre-fitted sheared screws 118, each of the plurality of pre-fitted sheared screws 118 connecting to respective tap wire holes of plurality of tap wire holes such that the at least one tap wire passing through the respective tap wire holes are tightened using a screw driver.

FIG. 2C shows a final compression connector 102 installed/securing with/the wires therein. In an implementation, as shown in FI Gs. 1A-1B, each of the plurality of pointed and piercing teeth's 112-1, 112-2, 112-3, 112-4 are provided surrounding to the central groove 104. When the connector 102 is pressed the plurality of pointed and piercing teeth's 112-1, 112-2, 112-3, 112-4 creates a cut on the accommodated main wire 106 and the at least one accommodated tap wire 110-1, 110-2, 110-3, 110-4 to thereby establish a splice connection between the accommodated main wire 106 and the at least one accommodated tap wire 110-1, 110-2, 110-3, 110-4.

The connector 102 is a C-shaped connector or is a substantially C-shaped.

Each of the plurality of pointed and piercing teeth's 112-1, 112-2, 112-3, 112-4 are conductive piercing teeth adapted to maintain splice connection connectivity between the accommodated main wire and the at least one accommodated tap wire.

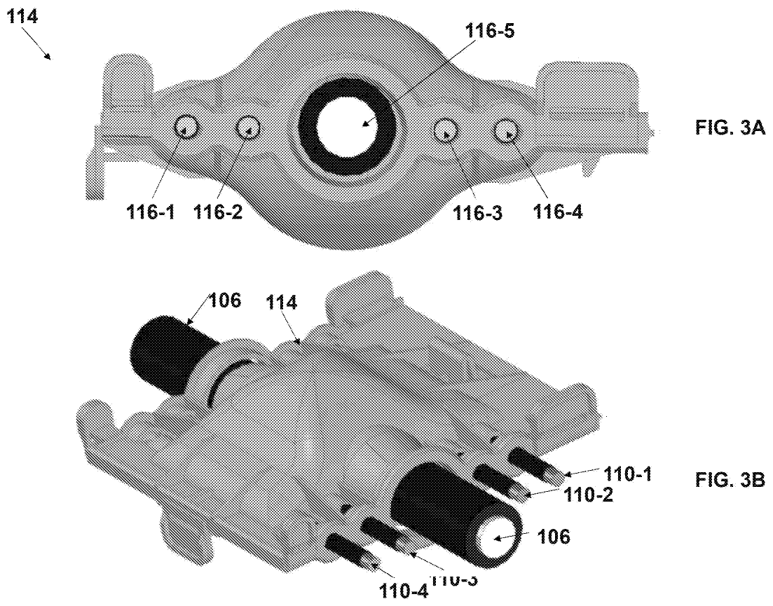

FIG. 3A illustrates a front view of an insulation cover adapted to enclose the connector, in accordance with the exemplary embodiment of the present subject matter. As shown in FIG. 3A, an insulation cover 114 is provided that is adapted to enclose the connector 102 therein. The insulation cover 114 includes a plurality of through and through holes 116-1, 116-2, 116-3, 116-4, 116-5.

FIG. 3B illustrates an isometric view of an insulation cover having enclosed the connector with wires secured therein, in accordance with the exemplary embodiment of the present subject matter. The plurality of through and through holes 116-1, 116-2, 116-3, 116-4, 116-5 matches the central groove 104 and the plurality of tap wire holes 108-1, 108-2, 108-3, 108-4 of the enclosed connector (as shown in FIGS. 1B and 2C), to allow entry and exit of the main wire 106 and the at least one tap wire 110-1, 110-2, 110-3, 110-4 therethrough.

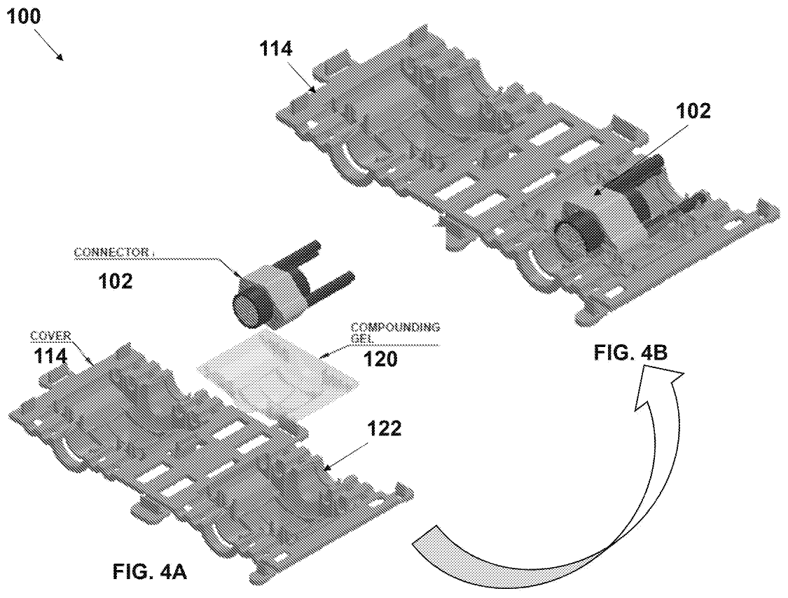

FIGS. 4A-4B illustrates an insulation cover in open position for receiving a compression connector before enclosing the compression connector, in accordance with the exemplary embodiment of the present subject matter.

As shown in FIGS. 4A and 4B, an insulation cover 114 is provided that is adapted to enclose the connector 102 therein. The insulation cover 114 is adapted to receive the connector 102 at placement guides 122 provided centrally at the insulation cover when in open position and completely encloses the connector in closed position of the insulation cover.

The insulation cover 114 comprises a snap fit mechanism to close the insulation cover.

The insulation cover comprises a gel 120 that enables the connector 102 to seat rigidly inside and thereby seals surrounding parts inside cover to form a seal tight enclosure for the connector.

The implementation of the present invention achieved certain advantages as summarized below:

From Connectors Perspective:

The wires passing through the connectors are very easy to install. Further, once the wire installation is done, the connector along with the wires can be placed in the insulation cover very easily and as per use conveniences. Thus, there is no need to any technical specialities or skills for installing this assembly which is an important advancement as compared to the conventionally available connectors and assemblies which required a specialized technical skill for installation.

Tap wire can tightened by using a regular screwdriver.

Piercing features: Main/Run groove has FIVE insulation piercing teeth to maintain connectivity and thermal stability.

Main/Run Wire Accommodates: Intended to be use with compact stranded aluminium PV cable, rated 2 kV and 90° C. Due to wire insulation tolerances, users must select a wire based on the insulation outer diameter (OD) being less than or equal to the maximum insulation OD in the table for the applicable connector.

Tap Wire Accommodates: Intended to be use with compact or concentric stranded copper PV cable, rated 2 kV and 90° C.

Installers are required to use one (1) to four (4) tap wire ports per screwing. Empty ports can be left empty. 4 tap wire ports that require installers to utilize a minimum of 1 tap port; other port scan be left empty.

Tap wire cable may require stripping, to ensure maximum surface contact with wires is achieved.

The connector 1s an uninsulated tin-plated aluminium compress 10n C-Tap Connector.

In a working mode, the assembly is a sealed wire connector system with rain tight rating and sunlight resistant. Category ZMWQ tested in accordance with UL 486D

From Covers Perspective:

Insulation cover allowing wires to enter and exit from both sides.

Snaps together with six (6) locking features that require a tool to open, preventing continuously opening and closing the cover.

Voltage Rating: 1.5 kV

Cover material properties provide V-0 flame rating and sunlight resistant.

Main/Run and tap wire alignment guides ensure wires seat in the gel properly.

Full perimeter gel-seal, when covers are mated, creating a rain tight seal.

Connector placement guide for proper seating of connector.

The user can use tap wire on both sides.

In a preferred implementation, following table show the dimensions of the connector, wire and cover during implementation:

| Wire accommodates | | | | | | | | | | | |
|---|---|---|---|---|---|---|---|---|---|---|---|
| | Run | Tap 1 | Tap 2 | Tap 3 | Tap 4 | Connector | | | Cover | | |
| Cataloge | conductor | Conductor | Conductor | Conductor | Conductor | hight | width | length | hight | width | length |
| no. | size (AL) | Size (CU) | Size (CU) | Size (CU) | Size (CU) | (H) | (W) | (L) | (H) | (W) | (L) |
| CIPC 750 | 750-500 kcmil | 10-6 AWG | 10-6 AWG | 10-6 AWG | 10-6 AWG | 2.75 | 1.61 | 0.94 | 2.3 | 5.37 | 4.85 |

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A compression connector assembly for securing wires therein, the compression connector assembly comprising:
a connector comprising:
a central groove to accommodate a main wire therethrough;
a plurality of tap wire holes, each of the plurality of tap wire holes adapted to accommodate at least one tap wire therethrough; and
a plurality of pointed and p1ercmg teeth's facing towards the accommodated main wire,
wherein each of the plurality of pointed and piercing teeth's are provided surrounding to the central groove such that when the connector is pressed the plurality of pointed and piercing teeth's pierces the accommodated main wire and the at least one accommodated tap wire to thereby establish a splice connection between the accommodated main wire and the at least one accommodated tap wire.

2. The compression connector assembly of claim 1, wherein the connector is a C-shaped connector, and each of the plurality of pointed and piercing teeth's are conductive piercing teeth adapted to maintain splice connection connectivity between the accommodated main wire and the at least one accommodated tap wire.

3. The compression connector assembly of claim 1, wherein the connector 1s substantially C-shaped.

4. The compression connector assembly of claim 1, wherein the main wire and the at least one tap wire is a shielded wire cable having a core conductor at least partially axially surrounded by a shield conductor which is at least partially axially surrounded by an insulative jacket.

5. The compression connector assembly of claim 1, wherein the main wire is an aluminum photovoltaic (PV) cable, and the at least one tap wire is a copper photovoltaic (PV) cable.

6. The compression connector assembly of claim 1, wherein each of the plurality of tap wire holes accommodate a single tap wire, and wherein the connector is adapted to include maximum up to four tap wires.

7. The compression connector assembly of claim 1, wherein the connector is made of aluminum (Al) material.

8. The compression connector assembly of claim 1, wherein the connector comprises a plurality of pre-fitted sheared screws, each of the plurality of pre-fitted sheared screws connecting to respective tap wire holes of plurality of tap wire holes such that the at least one tap wire passing through the respective tap wire holes are tightened using a screw driver.

9. The compression connector assembly of claim 1, further comprising an insulation cover adapted to enclose the connector therein, wherein the insulation cover comprises a plurality of through and through holes, matching the central groove and the plurality of tap wire holes of the enclosed connector, to allow entry and exit of the main wire and the at least one tap wire therethrough.

10. The compression connector assembly of claim 9, wherein the insulation cover 1s adapted to receive the connector at placement guides provided centrally at the insulation cover when in open position and completely encloses the connector in closed position, and wherein the insulation cover comprises a snap fit mechanism to close the insulation cover.

11. The compression connector assembly of claim 9, wherein the insulation cover comprises a gel that enables the main wire and the at least one tap wire to seat rigidly inside and thereby seals surrounding parts inside cover to form a seal tight enclosure for the connector.

12. A compression connector assembly for securing wires therein, the compression connector assembly comprising:
a connector comprising:
a central groove to accommodate a main wire therethrough;
a plurality of tap wire holes, each of the plurality of tap wire holes adapted to accommodate at least one tap wire therethrough; and
a plurality of pointed and p1ercmg teeth's facing towards the accommodated main wire,
wherein each of the plurality of pointed and piercing teeth's are provided surrounding to the central groove such that when the connector is pressed the plurality of pointed and piercing teeth's pierces the accommodated main wire and the at least one accommodated tap wire to thereby establish a splice connection between the accommodated main wire and the at least one accommodated tap wire; and
an insulation cover adapted to enclose the connector therein, wherein the insulation cover comprises a plurality of through and through holes, matching the central groove and the plurality of tap wire holes of the enclosed connector, to allow entry and exit of the main wire and the at least one tap wire therethrough.

13. The compression connector assembly of claim 12, wherein the insulation cover is adapted to receive the connector at placement guides provided centrally at the insulation cover when in open position and completely encloses the connector in closed position, and wherein the insulation cover comprises a snap fit mechanism to close the insulation cover.

14. The compression connector assembly of claim 12, wherein the insulation cover comprises a gel that enables the main wire and the at least one tap wire to seat rigidly inside and thereby seals surrounding parts inside cover to form a seal tight enclosure for the connector.

15. The compression connector assembly of claim 12, wherein the main wire is an aluminum photovoltaic (PV) cable, and the at least one tap wire is a copper photovoltaic (PV) cable.

16. A compression connector for securing wires therein, the compression connector comprising:
a central groove to accommodate a main wire therethrough;
a plurality of tap wire holes, each of the plurality of tap wire holes adapted to accommodate at least one tap wire therethrough; and
a plurality of pointed and piercing teeth's facing towards the accommodated main wire, wherein each of the plurality of pointed and piercing teeth's are provided surrounding o the central groove such that when the connector is pressed the plurality of pointed and piercing teeth's pierces on the accommodated main wire and the at least one accommodated tap wire to thereby establish a splice connection between the accommodated main wire and the at least one accommodated tap wire.

17. The compression connector of claim 16, wherein the connector is a C-shaped connector, and each of the plurality of pointed and piercing teeth's are conductive piercing teeth adapted to maintain splice connection connectivity between the accommodated main wire and the at least one accommodated tap wire.

18. The compression connector of claim 16, wherein the main wire is an aluminum photovoltaic (PV) cable, and the at least one tap wire is a copper photovoltaic (PV) cable.

19. The compression connector of claim 16, wherein each of the plurality of tap wire holes accommodate a single tap wire, and wherein the connector is adapted to include maximum up to four tap wires.

20. The compression connector of claim 16, wherein the connector comprises a plurality of pre-fitted sheared screws, each of the plurality of pre-fitted sheared screws connecting to respective tap wire holes of plurality of tap wire holes such that the at least one tap wire passing through the respective tap wire holes are tightened using a screw driver.
